(19) United States
(12) Patent Application Publication
(10) Pub. No.: US 2003/0150287 A1
(43) Pub. Date: Aug. 14, 2003

(54) Throttle retrofit

(76) Inventor: Nave Natan Lev-Ran, Givat-Shmuel (IL)

Correspondence Address: Perkins Coie LLP, 101 Jefferson Drive, Menlo Park, CA, 94025-1114, US

(21) Appl. No.: 10/261,728

(22) Filed: Sep. 30, 2002

Related U.S. Application Data
(60) Provisional application No. 60/356,174, filed on Feb. 14, 2002.

(51) Int. Cl. G05G 11/00

(52) U.S. Cl. 74/488

(57) ABSTRACT

A retrofit for a thumb-lever throttle vehicle includes a rotatable handgrip which can be sleeved over a handlebar of a vehicle and a lever shoe which engages a thumb-lever throttle. Also included is an elongated coupler which couples between said handgrip and said lever shoe, such that said handgrip manipulates the thumb-lever throttle to control a fuel supply to an engine of the vehicle.

### FIELD OF THE INVENTION

The present invention relates to a hand-controlled throttle of a vehicle.

### BACKGROUND OF THE INVENTION

Motorcycles and other lightweight vehicles are generally controlled by a hand throttle, which moderates the engine speed of the vehicle. The throttle is generally mounted on the handlebar of the vehicle and connected by means of a cable or cables enclosed in conduits to the vehicle's engine.

On motorcycles it is very common for the throttle to be controlled by a rotatable handgrip comprised of an elongated tubular handgrip commonly called a twist throttle. The handgrip is mounted on the end of the motorcycle's handlebar and held in place by means of a collar clamp assembly, which gives the handgrip the freedom to rotate. The collar clamp assembly further encloses a cable spool guide fastened to the end of the handgrip for winding and unwinding a control cable as the handgrip is rotated. Rotation of the handgrip controls the supply of fuel to the engine thus increasing or decreasing the speed of the vehicle.

In some vehicles such as all terrain vehicles (ATV), sea scooters and snowmobiles there is commonly used a handlebar-mounted throttle with a thumb-controlled lever, which moderates the speed of the vehicles.

Some users find the standard thumb controlled lever uncomfortable or inhibiting and manufacturers offer lever lengthening devices called thumb savers, which allow using the palm base to control the lever instead of the thumb.

### SUMMARY OF THE INVENTION

The present invention aims to provide a retrofit rotatable throttle control, which replaces a thumb-lever throttle used on various vehicles, such that the user is able to control the vehicle more easily with a rotatable hand grip device. This eliminates the fatigue that is often common to the continuous use of a thumb-lever throttle over lengthy periods of time and over long distances.

According to a preferred embodiment of the present invention, there is provided a retrofit for thumb-lever throttle vehicles including a rotatable handgrip which can be sleeved over a handlebar of a vehicle, lever shoe which engages a thumb-lever of a thumb-lever throttle, and an elongated coupler which couples between the handgrip and the lever shoe, such that the handgrip manipulates the thumb-lever throttle to control a fuel supply to an engine of the vehicle.

In accordance with some embodiments of the present invention, the handgrip is connected to a thumb-controlled lever using an enveloped and guided cable.

Alternatively, the handgrip is connected to the thumb-controlled lever using an external flexible strap.

Further alternatively, the handgrip is connected to the thumb-controlled lever using an external resilient strap.

In accordance with some embodiments of the present invention, the handgrip includes a return spring, which returns the thumb-controlled lever to a set position, when the handgrip is released.

In accordance with some embodiments of the present invention, a user can select between different response modes of the handgrip, in which, turning the handgrip by a set angle, moves the thumb controlled lever a smaller or larger distance.

According to another preferred embodiment of the present invention, there is provided a direct-acting retrofit for a thumb-lever throttle vehicle including a rotatable handgrip adapted for rotatably sleeving over a handlebar of a vehicle. There is also included a retrofit thumb-lever member, having a thumb-lever, an axial operating shaft and a coaxial spool guide, arranged for operating a thumb-lever throttle, and an elongated coupler arranged for operatively coupling the handgrip to one or other of the thumb-lever and the coaxial spool guide, thereby to operate the thumb-lever throttle.

According to an added embodiment of the present invention, the direct acting retrofit in which the retrofit thumb-lever member includes attachment means for fixably coupling the elongated coupler to the thumb-lever and for fixably coupling the elongated coupler to the coaxial spool guide.

According to one other embodiment of the present invention, the direct acting retrofit, in which there is an elongated coupler, includes an enveloped and guided cable.

According to another embodiment of the present invention, the direct acting retrofit includes the spool guide attachment means, which is radially adjustable so as to provide a variable operative association between the rotatable handgrip and the retrofit thumb-lever member.

According to an additional embodiment of the present invention, a preselected angle of rotation of the handgrip moves the thumb-lever from a minimum position to a maximum position.

According a further embodiment of the present invention, the rotatable handgrip of the direct acting retrofit includes a returning spring for returning the thumb-lever throttle to a preselected position.

According to one other embodiment of the present invention, in the elongated coupler of the direct acting retrofit is formed from a substance including: steel, non-ferrous metal and plastic.

According to another embodiment of the present invention, the thumb-lever throttle is operable using the thumb-lever.

According to one added embodiment of the present invention, the rotatable handgrip includes a locking element for retaining the rotatable handgrip in a preselected operative position.

According to an additional embodiment of the present invention, the thumb-lever member includes an operatively attachable coaxial spool guide and the coaxial spool guide is operatively attachable to said axial operating shaft of said thumb-lever member.

According to one further embodiment of the present invention, the coaxial spool guide is operatively attachable to an axial operating shaft of the thumb-lever throttle.

### BRIEF DESCRIPTION OF FIGURES

Particular exemplary embodiments of the present invention will be described with reference to the following figures, wherein identical structures, elements or parts, appearing in more than one figure are preferably labeled with the same or similar reference numbers in all the figures in which they appear, in which:

FIG. 1 is an illustration of a prior art thumb throttle mounted on a vehicle's handlebar, useful in explaining an exemplary embodiment of the present invention;

FIG. 2 is an illustration of a handgrip connected to a thumb throttle, in accordance with an exemplary embodiment of the present invention;

FIG. 3 is an illustration of a handgrip, in accordance with an exemplary embodiment of the present invention;

FIG. 4 is an illustration of an exploded view of a handgrip, in accordance with an exemplary embodiment of the present invention;

FIGS. 5A-5E are illustrations of optional variations of a handgrip, in accordance with some exemplary embodiments of the present invention;

FIGS. 6A-6B are illustrations of a variation of a handgrip connected to a thumb throttle, in accordance with an exemplary embodiment of the present invention;

FIGS. 7A-7B are illustrations of a variation of a handgrip connected to a thumb throttle, in accordance with an exemplary embodiment of the present invention;

FIGS. 8A-8E are illustrations of a variation of a handgrip connected to a thumb throttle, in accordance with an exemplary embodiment of the present invention;

FIG. 9 is a perspective view illustration of a retrofit thumb-lever member in operative association with the rotatable handgrip;

FIG. 10 is a plan view illustration of the retrofit thumb-lever member in operative association with the rotatable handgrip shown in FIG. 9;

FIG. 11 is a perspective view illustration of the retrofit thumb-lever member in operative association with the rotatable handgrip assembled on a handlebar;

FIG. 12 is a perspective view illustration of the retrofit thumb-lever member;

FIG. 13 is a perspective view illustration of a retrofit thumb-lever member having a radially adjustable spool guide connector;

FIG. 14 is a plan view illustration of the retrofit thumb-lever member shown in FIG. 13;

FIG. 15 is a perspective view illustration of a thumb-lever of retrofit thumb-lever member in operative association with the rotatable handgrip;

FIG. 16 is a perspective view of an attachable spool guide connector and a thumb-lever member;

FIG. 17 is a perspective view of an attachable spool guide connector operatively attached to a thumb-lever member; and

FIG. 18 is a perspective view of the retrofit thumb-lever member with the attached spool guide connector in operative association with the rotatable handgrip.

### DETAILED DESCRIPTION OF EMBODIMENTS

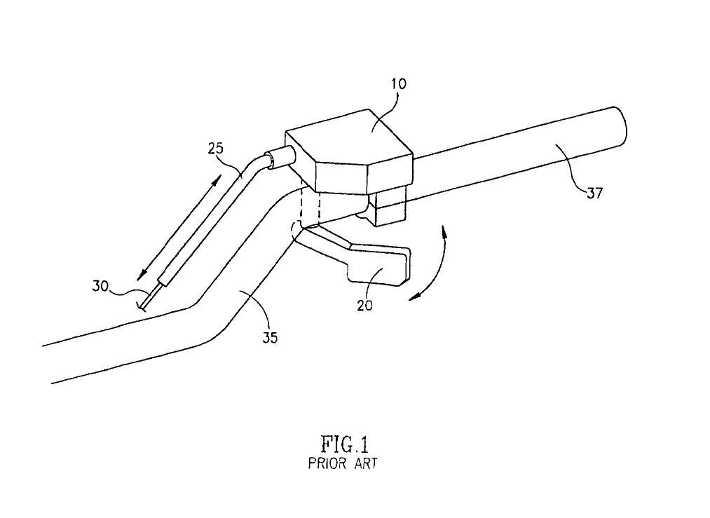

FIG. 1 is an illustration of a prior art thumb throttle referenced 10 mounted on a vehicle's handlebar referenced 35. This illustration is useful in explaining an exemplary embodiment of the present invention. A user typically grasps a handlebar end referenced 37 of handlebar 35 and uses his thumb to move a lever referenced 20 of thumb throttle 10, which regulates the fuel flow to the engine. Thumb throttle 10 is connected to the vehicle's engine by a cable referenced 30 typically made of a strong and flexible material. Examples of cable 30 include a twine made from steel or other metal or a flexible rod made from plastics or other substances. Cable 30 is typically protected in a reinforced plastic or rubber conduit referenced 25.

Some users of vehicles with handlebar steering prefer regulating the fuel flow to the engine with a handgrip such as implemented in motorcycles and some users prefer a thumb throttle 10 such as in vehicles mentioned in the background of this application.

In an exemplary embodiment of the present invention, a cam device referenced generally 100, illustrated in FIG. 3, is retrofitted over thumb throttle lever 20 and handlebar end 37 to allow control of lever 20 using a handgrip 15. Cam device 100 converts the rotational motion of handgrip 15 to a linear motion of lever 20.

Although cam device 100 is illustrated and described as a retrofit over thumb-lever throttle 20 of a vehicle, it should be noted that it can be adapted to retrofit over other user controls of a vehicle, for example over a control for changing gears.

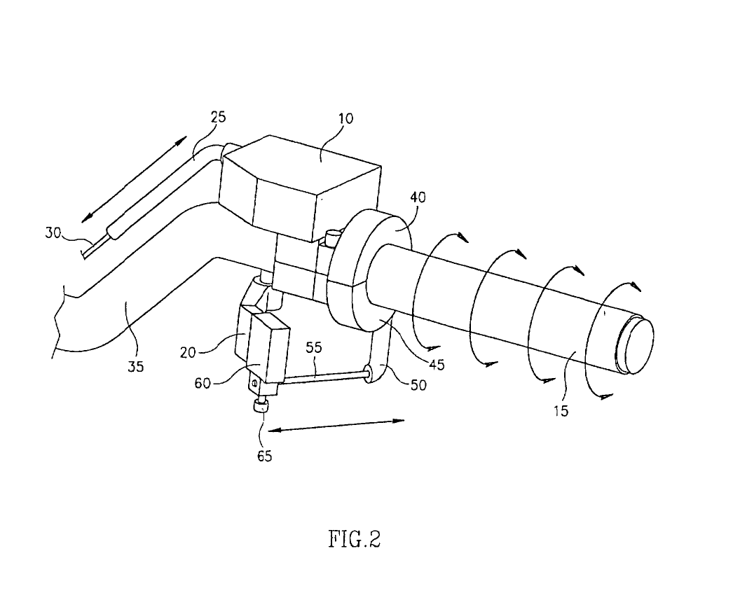

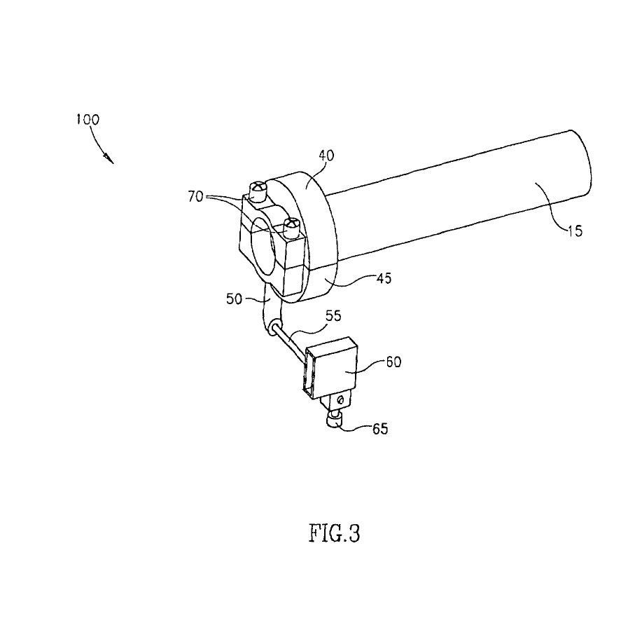

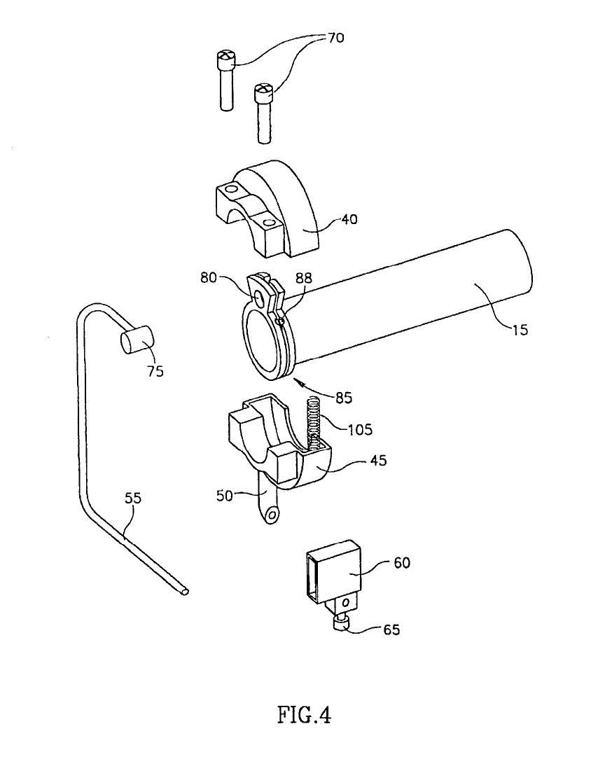

FIG. 2 and FIG. 4 will be used in conjunction with FIG. 3 to explain the implementation and function of cam device 100. FIG. 3 illustrates cam device 100. FIG. 2 illustrates cam device 100 fully deployed on a handlebar 35 of a vehicle. FIG. 4 illustrates an exploded view of cam device 100.

In an exemplary embodiment of the present invention, handgrip 15 is inserted like a sleeve over handlebar end 37. In accordance with some embodiments of the present invention, handgrip 15 is held in place with the freedom to rotate by the parts listed infra. One end of handgrip 15 comprises a spool guide referenced 85, mounted transversely on handgrip 15 (illustrated in FIG. 4). Optionally spool guide 85 is shaped primarily as a circle. Alternatively spool guide 85 is elliptical or any other shape, providing a varying response to the rotation of handgrip 15 at different angles of rotation.

In accordance with some embodiments of the present invention, an upper collar clamp referenced 40 and a lower collar clamp referenced 45, fit over cable spool guide 85 at the end of handgrip 15. Upper collar clamp 40 and lower collar clamp 45 are locked together with fastener pins referenced 70. Alternatively other methods are implemented to hold handgrip 15 in place over handle bar end 37 which serves as an inner bearing and allows rotational freedom. For example by using a cap referenced 5 as will be described infra.

In accordance with some embodiments of the present invention, handgrip 15 and lever shoe 60 are coupled by a cable 55 that converts the rotational motion of handgrip 15 to linear motion to move lever shoe 60, which is fixably attached to lever 20. Cable 55 is fastened to cable spool guide 85 at one end and to lever shoe 60 at the other end. Cable 55 is optionally formed from any flexible material such as plastic or metal twine.

In accordance with some embodiments of the present invention, lever shoe 60 is optionally formed from an elastic material such as rubber in order to allow some freedom in fitting it over lever 20. Alternatively lever shoe 60 is formed from a rigid material such as metal and attached to lever 20 for example with a screw (not shown). Alternatively, lever shoe 60 is configured as a slip-on case, for example, made from a fabric or cord and optionally fastened over lever 20 with a knot.

In accordance with some embodiments of the present invention, cable 55 has a cable terminator referenced 75, which latches into a cable terminator notch referenced 80 on cable spool guide 85, and maintains cable 55 connected to cable spool guide 85. Alternatively other methods are used to hold cable 55 to handgrip 15, such as a fastener screw as suggested infra for the other end of cable 55, terminating at lever shoe 60.

In accordance with some embodiments of the present invention, cable 55 is directed toward lever 20 by a cable guide referenced 50 in order to arrange for cable 55 to pull lever shoe 60 parallel to the direction of motion. Optionally, cable 55 wraps around cable spool guide 85, passing through cable guide 50 and emerging in the direction of lever 20. Optionally, cable guide 50 is free to rotate relative to lower collar clamp 45 in order to direct cable 55 toward lever 20.

In accordance with some embodiments of the present invention, cable 55 is fixably connected onto lever shoe 60, with a cable fastener screw referenced 65. Alternatively, other methods known in the art are used depending on the construct of lever shoe 60 as mentioned supra.

In an exemplary embodiment of the present invention, as illustrated in FIG. 4, cable spool guide 85 is formed having a narrow recess around its circumference to keep cable 55 in place as it wraps around cable spool guide 85.

In accordance with some embodiments of the present invention, cam device 100 does not inhibit the use of thumb throttle lever 20, for example, due to the flexibility of its components. Thus, a user can control the vehicle as preferred, using thumb throttle lever 20 or handgrip 15, or alternate between the two.

In accordance with some embodiments of the present invention, cam device 100 includes a switch (not shown) that is adapted to prevent handgrip 15 from rotating. For example, the switch may be placed on upper collar clamp 40 and when pushed into upper collar clamp 40, prevents movement of cable spool guide 85 handgrip 15 also cannot rotate. Optionally, a switch is used to select operation of the vehicle with thumb-lever 20.

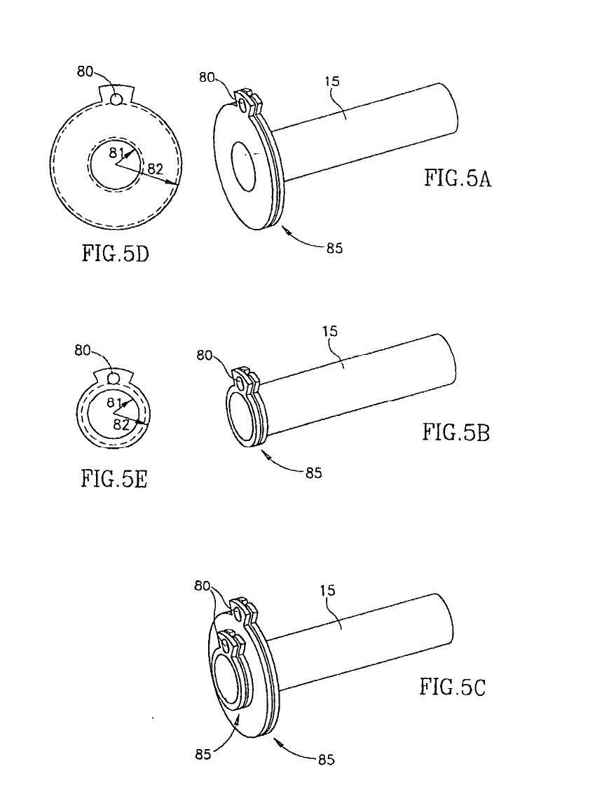

FIGS. 5A-5E are illustrations of optional variations of a handgrip 15, in accordance with some exemplary embodiments of the present invention.

In an exemplary embodiment of the present invention as illustrated in FIG. 5D and FIG. 5E, cable spool guide 85 has an inner radius referenced 81, which is approximately equal to the radius of handgrip 15, and an outer radius referenced 82. Radius 82 has a proportionate circumference about which cable 55 is wrapped. Circumference relative to radius 82, as shown in FIG. 5D, is proportionately larger than that shown in FIG. 5E and more of cable 55 is pulled onto cable guide 85 for the same angle of rotation of handgrip 15.

In FIG. 5A, spool guide 85 has a radius 82, which is much larger, relative to inner radius 81, than spool guide 85 shown in FIG. 5B. Therefore, a small rotation of handgrip 15 shown in FIG. 5A will pull lever 20 (FIG. 2), a greater distance than an equally small rotation of handgrip 15 as shown in FIG. 5B, so as to cause a larger change to the rate of fuel supply to the engine.

In accordance with some embodiments of the present invention, radius 82 is selected such that three quarters of a full rotation (270°) of handgrip 15, causes thumb-lever 20 to move from its minimum position to its maximum position. In accordance with some embodiments of the present invention, half a rotation (180°) of handgrip 15, is sufficient to move thumb-lever 20 from its minimum to its maximum position. Alternatively, a fourth of a full rotation (90°) is sufficient to move thumb-lever 20 from its minimum to its maximum position. Further, alternative radii 82 may be selected to provide additional angles of rotation so as to cause thumb-lever 20 to move from its minimum position to its maximum position.

In accordance with some embodiments of the present invention, as shown in FIG. 5D, the selected size of radius 82 is much larger than the size of radius 81 of handgrip 15 (e.g. twice the size). Alternatively as shown in FIG. 5E the selected size of radius 82 is only slightly larger than the size of radius 81 of handgrip 15 (e.g. 10% larger).

In accordance with some embodiments of the present invention, for example, cable spool guide 85 may be shaped like an ellipse having varying radii 82 at different angles.

In accordance with some embodiments of the present invention as illustrated in FIG. 5C, handgrip 15 comprises two cable spool guides 85 such as those seen in FIGS. 5A and 5B. When installing cam device 100, a user selects attachment of cable 55 (FIG. 4) to either the larger cable spool guide 85 or to the smaller cable spool guides 85. Alternatively or additionally, means such as a switch, as described infra, are supplied to select the larger or smaller cable spool guide 85. Optionally more than one cable is connected between handgrip 15 and lever shoe 60, cable spool guides 85 are not fastened to handgrip 15 but rather rotate freely about handgrip 15. A user can lock a selected spool guide 85 to handgrip 15 during installation, for example, with a tightening screw referenced 88, as illustrated in FIG. 4.

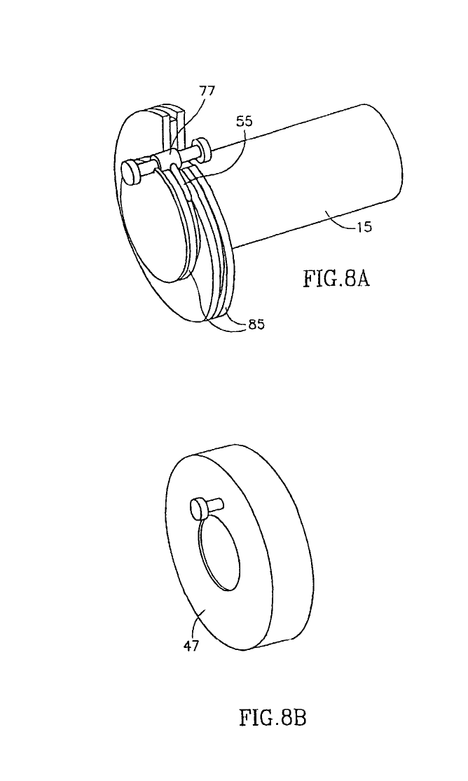

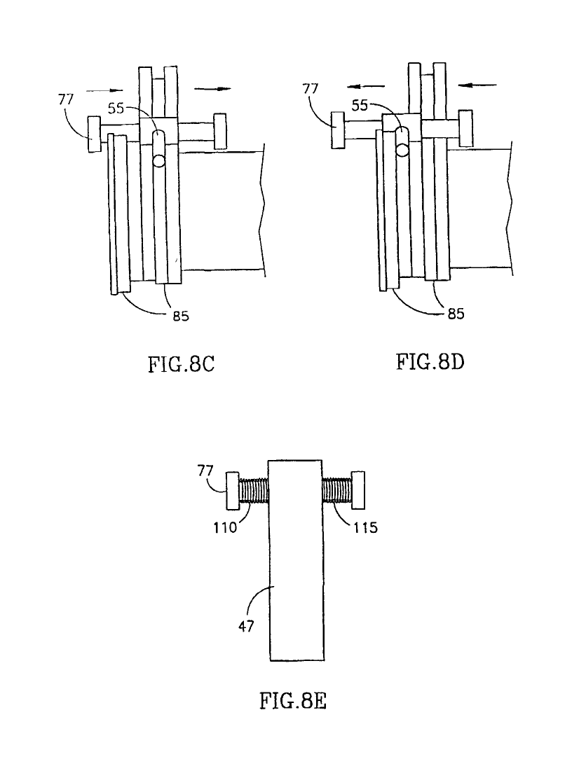

FIGS. 8A-8E illustrate an exemplary embodiment of the present invention, in which the user can choose between one or more modes of operation by selecting an active cable spool guide 85. As illustrated in FIG. 8A a switch referenced 77 replaces cable end 75 in order to allow selection of an active cable spool guide 85. Switch 77 and cable spool guides 85 are enclosed in a protective housing 47 (FIG. 8B), which keeps switch 77 in place. FIGS. 8A-8E illustrate embodiments of the present invention with two cable spool guides 85.

Optionally more than two cable spool guides are employed to allow selection of multiple modes providing varying response rates to rotation of handgrip 15.

In an exemplary embodiment of the present invention, when handgrip 15 is in its rest (untorqued) position, a user can select a larger or a smaller cable spool guide 85, as described supra, by moving switch 77 to the right or left side as illustrated in FIGS. 8C and 8D.

In accordance with some embodiments of the present invention one or more springs referenced 110 and/or 115 are placed on either or both sides of housing 47 (as illustrated in FIG. 8E) on switch 77 in order to set a preferential position for switch 77.

In accordance with some embodiments of the present invention, a returning spring referenced 105 (FIG. 4) is connected for example between handgrip 15 or cable spool guide 85 and upper collar clamp 40 or lower collar clamp 45. The returning spring assists in returning handgrip 15 to its rest (untorqued) position (i.e. optionally releasing lever 20, when handgrip 15 is released). A stronger spring requires a user to exert more force in order to turn handgrip 15, thus, in accordance with some embodiments of the present invention a user selects a spring according to the force desired to rotate handgrip 15.

In accordance with some embodiments of the present invention, spring 105 is formed from metal or any other known elastic material. Alternatively spring 105 comprises an elastic material in the form of a flat elastic band.

In accordance with some embodiments of the present invention, cable 55 comprises a spring or spring like material and acts as a returning spring. Alternatively or additionally, cable 55 is sheathed by a spring.

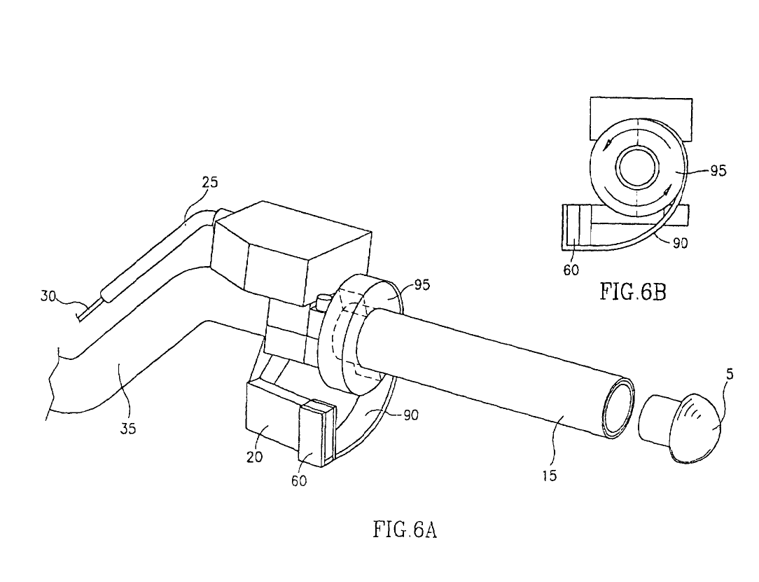

FIGS. 6A-6B are illustrations of an exemplary implementation of a variation of cam device 100 deployed on a vehicles handlebar 35 according to an exemplary embodiment of the present invention. In FIGS. 6A-6B the connection between handgrip 15 and lever shoe 60 is achieved using an external flexible strap referenced 90 made, for example, from plastic or metal or any other suitable material. Flexible strap 90 wraps externally around a strap guide referenced 95 and differs from cable 55 by being generally more rigid. Thus, it is not installed internal to an enveloping guide 50 and encasement (upper clamp 40 and lower clamp 45) like cable 55 but rather is fastened at the ends and guided by strap guide referenced 95. In accordance with some embodiments of the present invention, an external flexible strap allows a user to visually assure the functionality of the connection, whereas an internal cable may snap without warning.

In an exemplary embodiment of the present invention, strap guide 95, configured as a solid circular circumference (as shown in FIGS. 6A-6B) is fitted onto handgrip 15. Flexible strap 90 is fixed to strap guide 95 and connected to lever shoe 60. By turning handgrip 15 lever 20 is pulled toward handgrip 15 or released, thus handgrip 15 moderates the fuel flow to the engine.

In accordance with some embodiments of the present invention, strap guide 95 is configured as only parts of a solid circle, for example, an inner circumference, an outer circumference and two radial flaps, as shown by the dotted lines in FIG. 6A.

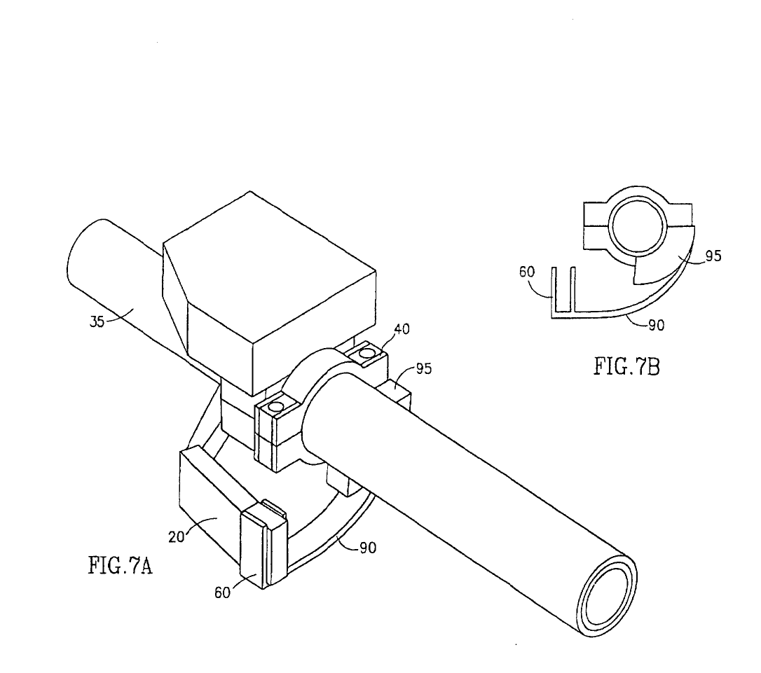

FIGS. 7A-7B illustrate an exemplary implementation of cam device 100 according to an exemplary embodiment of the present invention. In FIGS. 7A-7B the connection between handgrip 15 and lever shoe 60 is achieved using an external resilient strap 90 made for example from plastic or metal or any other suitable material. Resilient strap 90 is able to push and pull lever shoe 60 and is guided by a strap guide 95 comprising only a small arc for example a fourth of a complete circle (as illustrated in FIGS. 7A-7B). Optionally, strap guide 95 is non circular, for example an elliptic arc thus causing a varying response to turning handgrip 15.

In accordance with some embodiments of the present invention, lever shoe 60 is configured as one piece with resilient strap 90, for example, a one-piece plastic molding.

In accordance with some embodiments of the present invention strap guide 95 and lever shoe 60 are coupled using a rigid bar with a hinge on both ends (not shown), connected at one end to a strap guide 95 (such as shown in FIG. 6A) and at the other end to lever shoe 60. This coupling effectively causes strap guide 95 to directly operate shoe 60. The hinges allow a minimal degree of freedom so that the connection will not break as handgrip 15 is rotated.

In accordance with some embodiments of the present invention, a cap 5 is inserted into the end of handlebar 35. Cap 5 prevents dust and moisture from entering handlebar 35, allows attaching streamers and/or helps to prevent handgrip 15 from sliding off handlebar end 37. Alternatively, cap 5 is inserted into handgrip 15 or handgrip 15 is sealed on the end.

In accordance with some embodiments of the present invention, the end of handgrip 15 as illustrated in FIG. 6A and FIG. 7A includes a circular ring similar to cable spool guide 85 as shown in FIG. 5B. Notch 80 is not needed in order to keep handgrip 15 in place on handlebar 35 under upper clamp 40 and lower clamp 45 and to allow rotational motion.

Optionally, handlebar end 37 is covered with a protective cover for example a fixed handgrip made of rubber or plastic, over which handgrip 15 is fitted and able to rotate smoothly. Alternatively, the protective cover is removed in order to install handgrip 15. In addition, handgrip 15 is manufactured having different diameters in order to fit different types and models of vehicles. Furthermore, cam device 100 may be fitted to a handle bar in accordance with a variety of configurations. For example, one exemplary configuration is a handgrip 15, comprising an upper and lower portions, which are assembled over handlebar end 37. Thus handgrip 15 may be assembled directly over handlebar end 37 instead of being slipped on.

Additionally, one or more slip rings of suitable sizes are inserted over handlebar end 37 to support handgrip 15, thus preventing handgrip 15 from wobbling and allowing smooth rotation. Optionally, the slip rings include ball bearings to further reduce friction. Alternatively, cam device kit 100 is provided with one or more slip rings of various sizes, in order to match various sized handlebar ends 37 and handgrip 15. Further, a cylindrical shaped support, for example, formed from plastic or other suitable material, is slid onto handlebar end 37 in order to support handgrip 15. Optionally, the cylindrical shaped support is configured having grooves or protrusions about its circumference, which match respective grooves or protrusions within handgrip 15 in order to achieve smooth rotation of handgrip 15.

Handgrip 15 is generally more comfortable to use than thumb throttle lever 20 since it is controlled by a users hand, which is generally already gripping handle bar end 37 to steer the vehicle. Muscles are not subject to fatigue or trauma as is the case when controlling a thumb throttle lever 20 continuously with the thumb. Handgrip 15 also offers less distraction for a user than a thumb throttle lever 20, since a users hands are generally on handle bar ends 37. A user need not divert his line of sight in order to place his thumb over thumb throttle lever 20.

Also, handgrip 15 overcomes user handicap limitations, for example, of users with problems using their thumbs. Optionally, in order to enhance a user's grip or enhance a user's comfort, handgrip 15, is covered or coated with an optional substance such as rubber or sponge.

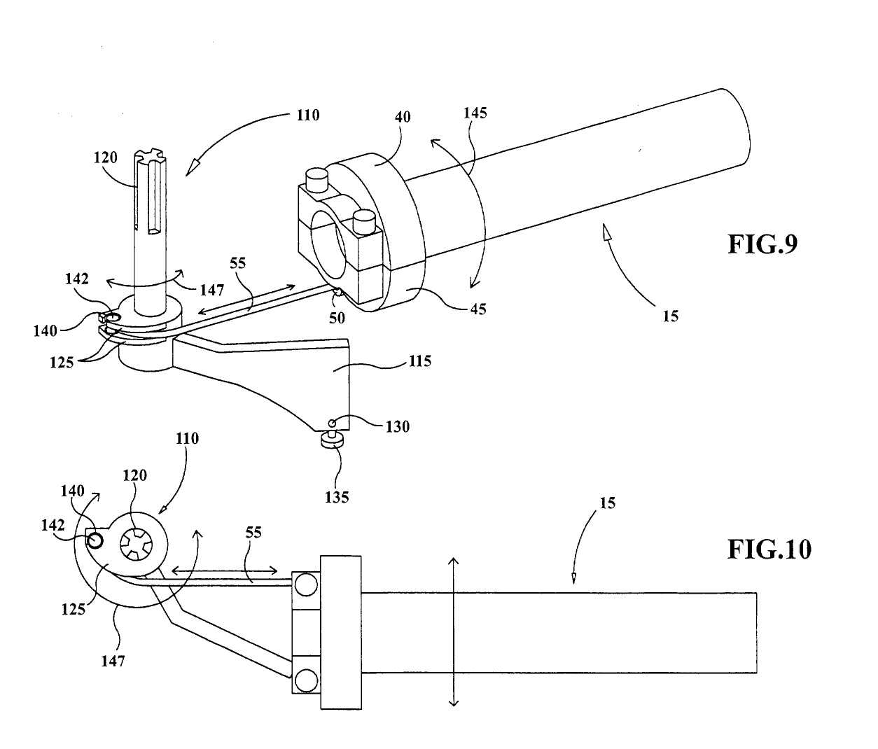

Reference is now made to FIGS. 9-12, in which are illustrated an alternative provision to operate the thumb-lever throttle 10, in accordance with a further embodiment of the present invention. The original thumb-lever 20 is replaced with an alternative thumb-lever member generally referenced 110. Thumb-lever member 110 is formed having a thumb-lever referenced 115, an axial operating shaft referenced 120 and coaxial spool guides referenced 125. Thumb-lever 115 has an attachment aperture referenced 130 and fastening screw referenced 135, disposed at the extremity of lever 115. Spool guides 125 have a cable terminator fastener referenced 140 so as to retain a cable terminator referenced 142 and operating cable referenced 55 between guides 125.

One end of operating cable 55 is connected to cable terminator notch 80 of spool guide 85 (as disclosed hereinabove in relation to FIG. 4) of handgrip 15. Cable 55 passes through cable guide 50 so as to attach cable terminator 142 to cable terminator fastener 140. Rotating handgrip 15 in accordance with arrow 145, thumb-lever member 110 is rotated in accordance with arrow 147, thereby to operate thumb-lever throttle 10.

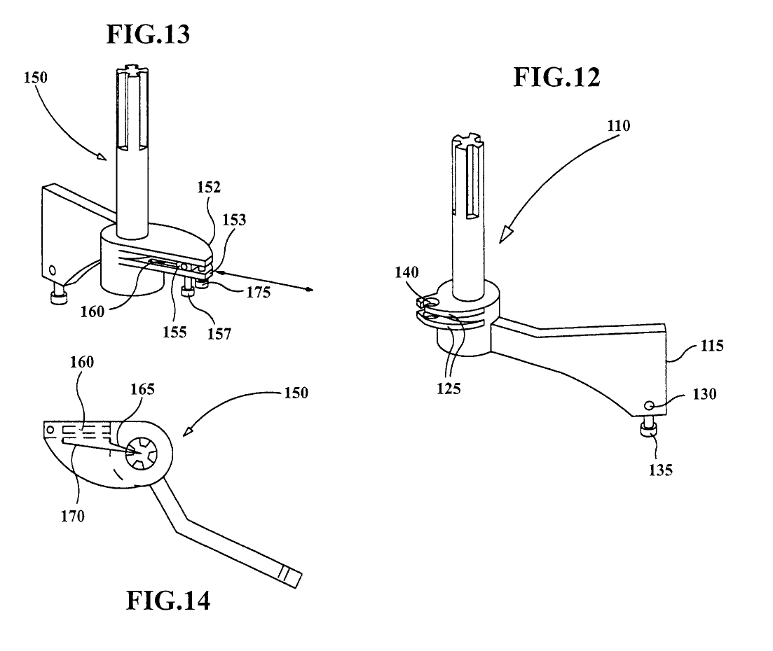

There is seen in FIG. 12, that provision is only made for a single point of attachment of cable 55 to spool guides 125, so that the operational association between rotation of handgrip 15 and throttle 10 is fixed. Optionally, a variety of spool guides 125 having different shapes and sizes are formed separately from and attachable to operating shaft 120.

Referring now to FIGS. 13-14, there is seen, in accordance with an alternative embodiment of the present invention, a thumb-lever member referenced 150 having extended spool guides referenced 152 and 153. Guide 153 has disposed therein an adjusting slot referenced 160 and slidably attached thereto is a cable attachment block referenced 155 and attachment screw referenced 157 as well as a slot locking screw referenced 175. Cable 55 is adjustably attached between spool guides 152 and 153 by cable attachment block 155 and screw 157. The radial distance of the point of attachment is variable between the extremities of slot 160 as indicated by arrows 165 and 170 so as to provide varying throttle operation in accordance with the rotation of handgrip 15.

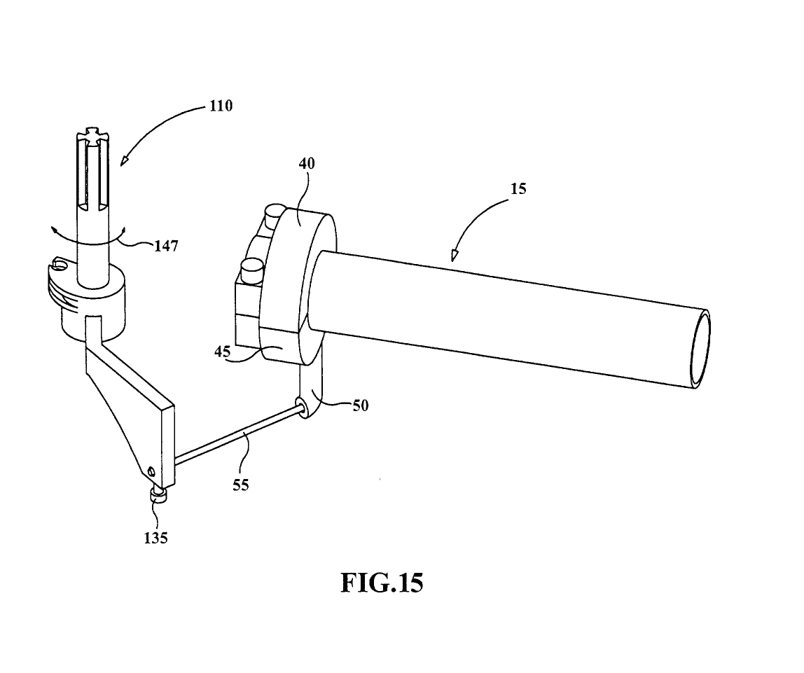

In accordance with an additional embodiment of the present invention, referring now to FIG. 15, cable 55 is attached to attachment aperture 130 using fastening screw 135 so as to provide direct operation of thumb-lever 115 by rotating handgrip 15. Further, in regard to each of the embodiments recited hereinabove in relation to FIGS. 9-15, the driver of the vehicle is able to operate thumb-lever member 110 by pressing lever 115 instead of by rotating handgrip 15.

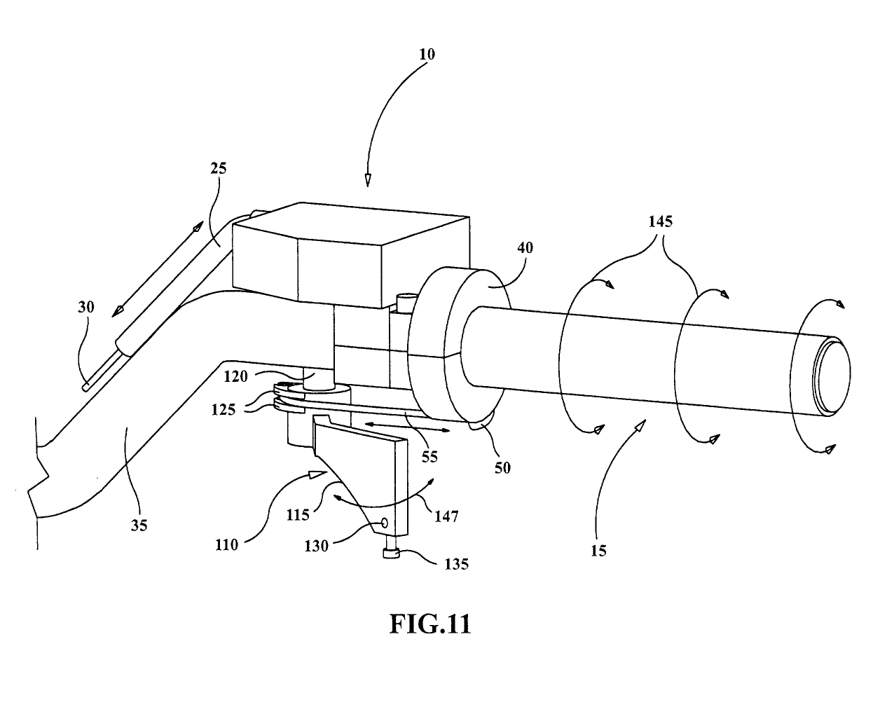

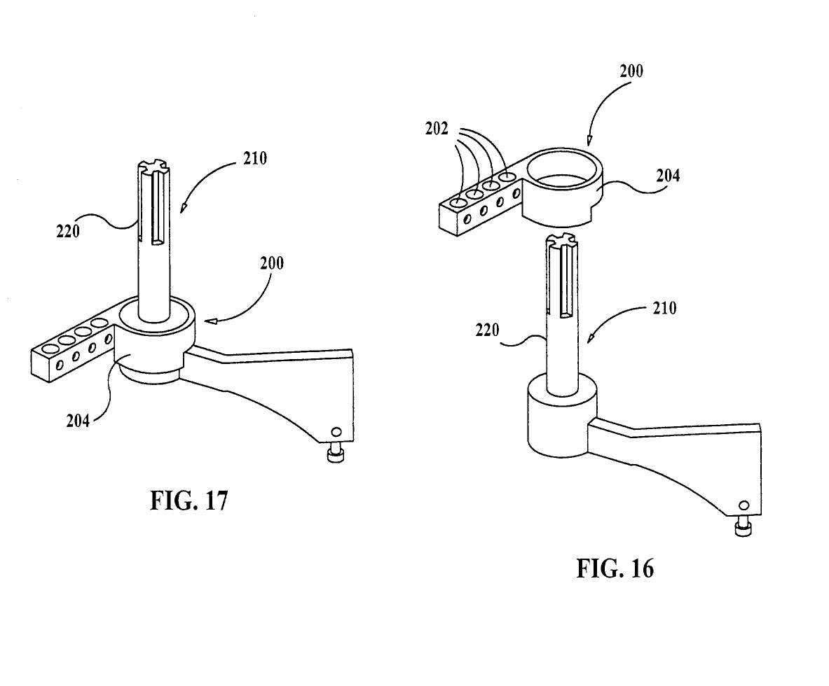

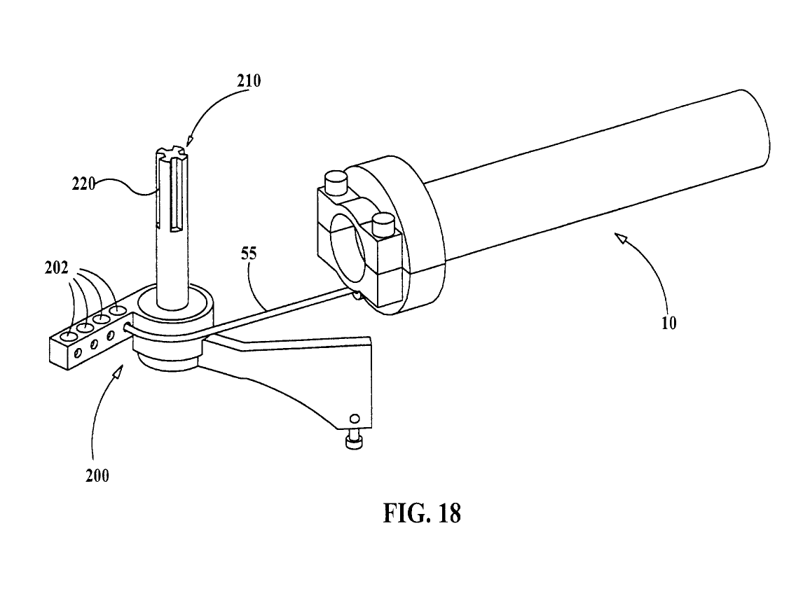

In accordance with further embodiments of the present invention, referring now to FIGS. 16-18, there is seen a separately formed spool guide generally referenced 200 (FIG. 16), which is operatively attachable to an axial operating shaft referenced 220 of a thumb-lever member referenced generally 210. Spool guide 200 is formed having one or more cable terminator fasteners referenced 202 spaced at different radial distances from the axis of rotation of thumb-lever member 210 to so as to provide varying throttle operation in accordance with the rotation of handgrip 15. Furthermore, in accordance with one attachment variation, spool guide 200 has a sleeve referenced 204 thereby to sleeve-fit spool guide 200 over axial operating shaft 220 as seen in FIG. 17. In order to sleeve-fit spool guide 200 to thumb-lever member 210, thumb-lever member 210 is removed from thumb-lever throttle 10 (as disclosed hereinabove in relation to FIG. 11). Furthermore, there is seen in FIG. 18, thumb-lever member 210, having spool guide 200 attached thereto, in operative engagement with handgrip 15 by means of cable 55.

It will be appreciated by persons skilled in the art that the example, of a sleeve-fit mechanism disclosed hereinabove in relation to FIGS. 16-18, represents one of many alternative attachment means for attaching a spool guide to a thumb lever throttle.

The present invention has been described using non-limiting detailed descriptions of embodiments thereof that are provided by way of example and are not intended to limit the scope of the present invention. It should be understood that features and/or steps described with respect to one embodiment may be used with other embodiments and that not all embodiments of the present invention have all of the features and/or steps shown in a particular figure or described with respect to one of the embodiments. Variations of embodiments described will occur to persons of the art.

It is noted that some of the above described embodiments may describe the best mode contemplated by the inventors and therefore may include structure, acts or details of structures and acts that may not be essential to the present invention and which are described as examples. Structure and acts described herein are replaceable by equivalents, which perform the same function, even if the structure or acts are different, as known in the art. Therefore, the scope of the present invention is limited only by the elements and limitations as recited in the claims. When used in the following claims, the terms “comprise”, “include”, “have” and their conjugates mean “including but not limited to”.

The invention claimed is:

1. A retrofit for a thumb-lever throttle vehicle comprising:
a rotatable handgrip which can be sleeved over a handlebar of a vehicle;
a lever shoe which engages a thumb-lever of a thumb-lever throttle; and
an elongated coupler which couples between said handgrip and said lever shoe, such that said handgrip manipulates the thumb-lever throttle to control a fuel supply to an engine of the vehicle.

2. A retrofit according to claim 1, in which said elongated coupler, which couples between said handgrip and said lever shoe, comprises an enveloped and guided cable.

3. A retrofit according to claim 1, in which said elongated coupler, which couples between said handgrip and said lever shoe, comprises an external non-guided flexible strap.

4. A retrofit according to claim 1, in which said elongated coupler, which couples between, said handgrip and said lever shoe, comprises an external non guided resilient strap.

5. A retrofit according to claim 1, in which said elongated coupler, which couples between said handgrip and said lever shoe, comprises a rigid bar with hinges at both ends.

6. A retrofit according to claim 1 includes a returning spring, which returns said thumb-lever throttle to a set position.

7. A retrofit according to claim 2, in which said cable is made of metal.

8. A retrofit according to claim 2, in which said cable is made of plastic.

9. A retrofit according to claim 1, in which half a rotation of said handgrip moves said thumb-lever from its minimum position to its maximum position.

10. A retrofit according to claim 1, in which three-fourths of a rotation of said handgrip moves said thumb-lever from its minimum position to its maximum position.

11. A retrofit according to claim 1, in which a fourth of a rotation of said handgrip moves said thumb-lever from its minimum position to its maximum position.

12. A retrofit according claim 1, in which, during installation, a cable guide is selected to determine the response rate of said thumb-lever to rotation of said handgrip.

13. A retrofit according to claim 1, in which during use a cable guide is selected to determine the response rate of said thumb-lever to rotation of said handgrip.

14. A direct acting retrofit for a thumb-lever throttle vehicle comprising:
a rotatable handgrip adapted for rotatably sleeving over a handlebar of a vehicle;
a retrofit thumb-lever member, having a thumb-lever, an axial operating shaft and a coaxial spool guide, arranged for operating a thumb-lever throttle; and
an elongated coupler arranged for operatively coupling said handgrip to at least one of said thumb-lever and said coaxial spool guide, thereby to operate the thumb-lever throttle.

15. A direct acting retrofit according to claim 14 wherein said retrofit thumb-lever member includes attachment means for fixably coupling said elongated coupler to said thumb-lever.

16. A direct acting retrofit according to claim 14 wherein said coaxial spool guide includes spool guide attachment means for fixably coupling said elongated coupler to said coaxial spool guide.

17. A direct acting retrofit according to claim 14, in which said elongated coupler includes an enveloped and guided cable.

18. A direct acting retrofit according to claim 14 wherein said spool guide attachment means is radially adjustable so as to provide a variable operative association between said rotatable handgrip and said retrofit thumb-lever member.

19. A direct acting retrofit according to claim 14, wherein a preselected angle of rotation of said handgrip moves said thumb-lever from a minimum position to a maximum position.

20. A direct acting retrofit according to claim 14 wherein said rotatable handgrip includes a returning spring for returning said thumb-lever throttle to a preselected position.

21. A direct acting retrofit according to claim 14, wherein said rotatable handgrip includes a locking element for retaining said rotatable handgrip in a preselected operative position.

22. A direct acting retrofit according to claim 14 wherein said elongated coupler is formed from a substance selected from the group of substances including: steel, non-ferrous metal and plastic.

23. A direct acting retrofit according to claim 14, wherein the thumb-lever throttle is operable using said thumb-lever.

24. A direct acting retrofit according to claim 14, wherein said thumb-lever member includes an operatively attachable coaxial spool guide.

25. A direct acting retrofit according to claim 14, wherein said coaxial spool guide is operatively attachable to said axial operating shaft of said thumb-lever member.

26. A direct acting retrofit according to claim 14, wherein said coaxial spool guide is operatively attachable to an axial operating shaft of the thumb-lever throttle.
